(19) United States
(12) Patent Application Publication
(10) Pub. No.: US 2008/0182581 A1
(43) Pub. Date: Jul. 31, 2008

(54) MOBILE COMMUNICATION SYSTEM AND SOFT HANDOVER METHOD USED FOR THE SAME

(76) Inventor: YASUAKI ISHIKAWA, Tokyo (JP)

Correspondence Address: NEC CORPORATION OF AMERICA, 6535 N. STATE HWY 161, IRVING, TX, 75039, US

(21) Appl. No.: 12/015,841

(22) Filed: Jan. 17, 2008

(30) Foreign Application Priority Data
Jan. 25, 2007 (JP) 2007-014988

(51) Int. Cl. H04Q 7/20

(52) U.S. Cl. 455/442

(57) ABSTRACT

A base transceiver station of a soft handover destination node does not perform control by using Hybrid Automatic Repeat Request, and a base transceiver station of a soft handover origin node sends data to a mobile node according to control performed by using Hybrid Automatic Repeat Request when the soft handover occurs. A radio network controller sends data destined for the mobile node only to the base transceiver station of the soft handover origin node. When the data is transferred from the base transceiver station of the soft handover origin node, the radio network controller transfers the data to the base transceiver station of the soft handover destination node. When a request to resend the data is received from the base transceiver station of the soft handover destination node, the radio network controller transfers the resend request to the base transceiver station of the soft handover origin node.

This application is based upon and claims the benefit of priority from Japanese patent application No. 2007-014988, filed on Jan. 25, 2007, the disclosure of which is incorporated herein in its entirety by reference.

### BACKGROUND OF THE INVENTION

1. Field of the Invention

The present invention relates to a mobile communication system and a soft handover method used for the same.

2. Description of the Related Art

The CDMA (Code Division Multiple Access) that has been mainly used as the third generation mobile communication system and the OFDMA (Orthogonal Frequency Division Multiple Access) that is a candidate for the next generation mobile communication system have features (soft handover) for providing stable services without breaking communication by causing a mobile terminal to simultaneously communicate with two or more Base Transceiver Stations (hereinafter referred to as BTS) when the mobile terminal moves from one cell to another. The CDMA and the OFDMA also have high communication performance by using Hybrid Automatic Repeat Request (hereinafter referred to as HARQ) technique.

In the mobile communication system, high speed communication (such as the high quality streaming communication for moving pictures) is expected to be provided for a moving terminal and the HSDPA (High Speed Downlink Packet Access) technique is standardized in W-CDMA (Wideband-CDMA).

Conventional soft handover and the HARQ performed in the CDMA mobile communication system will be described. They will be described below by taking a case where a Mobil Node (hereinafter referred to as an MN) communicates with a Correspondent Node (hereinafter referred to a CN) as an example.

FIG. 1 is a block diagram showing the configuration of a conventional mobile communication system.

As shown in FIG. 1, the mobile communication system includes higher level network 1 including a core network (hereinafter simply referred to as a higher level network), Radio Network Controller 2 (hereinafter referred to as an RNC), and a plurality of BTSes (only BTS 21 and BTS 22 are exemplified in FIG. 1).

RNC 2 is connected with higher level network 1, while including a plurality of BTSes (BTS 21 and BTS 22) connected thereto. CN 3 can communicate with MN 61 when CN 3 connects with higher level network 1.

Each of BTS 21 and BTS 22 is capable of wirelessly communicating with a plurality of MNs (only MN 61 is shown in FIG. 1) which are present in a cell managed by BTS 21 or BTS 22. In the mobile communication system shown in FIG. 1, cell 31 and cell 32 are located side by side with cell 31 being managed by BTS 21 and cell 32 being managed by BTS 22.

MN 61 reports information on the received power level of each BTS to RNC 2 in a predetermined cycle. MN 61 determines whether received data is erroneous or not by using HARQ. When the received data has no error, MN 61 sends a response of ACK (ACKnowledgments) to a BTS that originates the wireless transmission. When the received data has an error, MN 61 sends a response of NACK (Negative ACKnowledgments) to a BTS that originates the wireless transmission. When MN 61 receives the same data from a plurality of BTSes, MN 61 Rake-combines the radio signals to perform HARQ by using the data reproduced from the Rake-combined signals.

RNC 2 determines the BTS for managing a cell in which MN 61 is present, and relays the data exchanged between CN 3 and MN 61 through the determined BTS. RNC 2 also determines whether MN 61 needs soft handover based on information on a received power level of each BTS reported by MN 61.

BTS 121 and BTS 122 relay data exchanged between CN 3 and MN 61 through higher level network 1 and RNC 2. Here, BTS 121 and BTS 122 send data to be sent to MN 61 with a redundant bit for detecting an error or a redundant bit for correcting an error added by using HARQ. When BTS 121 and BTS 122 receive a NACK response from MN 61, BTS 121 and BTS 122 resend data to MN 61 by using HARQ.

Conventional soft handover will be described in the above mentioned configuration by taking a case where MN 61 moves from cell 31 to cell 32 by using FIG. 2. When MN 61 moves from cell 32 to cell 31, the operations performed by BTS 21 and BTS 22 are basically the same as those described above except that those performed by BTS 21 and BTS 22 are switched.

MN 61 communicates with CN 3 via BTS 21, RNC 2 and higher level network 1 in cell 31 that originates the soft handover (step 301). Here, RNC 2 sends data, which is received from CN 3 and destined for MN 61, to BTS 21 (step 302). BTS 21 converts data, which is received from RNC 2 and destined for MN 61, into radio signals and sends them to MN 61 (step 303). [Situation A].

When MN 61 moves near to the boundary of cell 32 (step 304), the soft handover from cell 31 to cell 32 is performed according to the procedure described below.

As mentioned above, MN 61 reports information on the received power level of the radio signals sent from BTS 21 and BTS 22 to RNC 2 in a predetermined cycle. RNC 2 determines whether MN 61 needs the soft handover from BTS 21 to BTS 22 based on the information on the received power level for each BTS reported by MN 61. If the soft handover is performed (step 305) and RNC 2 receives data destined for MN 61 from CN 3 (step 306), RNC 2 sends the data to BTS 21 and BTS 22 (step 307).

BTS 21 and BTS 22 convert data, which is received from RNC 2 and destined for MN 61, into radio signals and send the signals to MN 61 (steps 308 and 309). Here, the same data is sent from BTS 21 and BTS 22 to MN 61.

MN 61 Rake-combines the radio signals received from BTS 21 and BTS 22 (step 310). This situation is the soft handover to MN 61 (step 311). [Situation B].

When RNC 2 determines that the soft handover to MN 61 can finish based on the information on the received power level of BTS 21 and BTS 22 reported by MN 61 (step 312), RNC 2 sends the data that is received from CN 3 and that is destined for MN 61 only to BTS 22 (steps 313, 314).

When BTS 22 receives data destined for MN 61 from RNC 2, BTS 22 converts the data into radio signals and sends the signals to MN 61 (step 315). Here, MN 61 receives data only from BTS 22 (step 316). Then, the soft handover finishes. [Situation C].

Now, a conventional HARQ will be described with reference to FIG. 3.

FIG. 3 is a sequence diagram showing the procedure of the conventional HARQ.

MN 61 is in cell 31 and communicates with CN 3 via BTS 21, RNC 2 and higher level network 1 (step 321). Here, RNC 2 sends data that is received from CN 3 and destined for MN 61 to BTS 21 (step 322). BTS 21 converts data that is received from RNC 2 and destined for MN 61 into radio signals and sends the signals to MN 61 (step 323).

As mentioned above, MN 61 and BTS 21 are performing the HARQ process: MN 61 determines whether the received data is erroneous. When the received data has no error, MN 61 sends a response of ACK to BTS 21. When the received data has an error, MN 61 sends a response of NACK to BTS 21 (step 324).

When BTS 21 receives the response of NACK from MN 61, BTS 21 resends the data to MN 61 (step 325).

Now, operations that may cause a problem in a case where the soft handover is performed while HARQ is being used will be described with reference to FIG. 4, assuming that the abovementioned processing has been performed. The operation will be described by taking a case where MN 61 moves from cell 31 to cell 32 as an example. When MN 61 moves from cell 31 to cell 32, the operations performed by BTS 21 and BTS 22 are basically the same as those described above except that those performed by BTS 21 and BTS 22 are switched.

MN 61 communicates with CN 3 via BTS 21, RNC 2 and higher level network 1 in cell 31 that originates the soft handover (step 341). Here, RNC 2 sends data, which is received from CN 3 and destined for MN 61, to BTS 21 (step 342). BTS 21 converts data, which is received from RNC 2 and destined for MN 61, into radio signals and sends the signals to MN 61 (step 343). [Situation A].

MN 61 determines whether the received data is erroneous by using HARQ. When the received data has no error, MN 61 sends a response of ACK to BTS 21. When the received data has an error, MN 61 sends a response of NACK to BTS 21 (step 344). When BTS 21 receives the NACK response from MN 61, BTS 21 resends data to MN 61 (step 345).

When MN 61 moves near to the boundary of cell 32 (step 346), the soft handover from cell 31 to cell 32 is performed according to the procedure described below.

As mentioned above, MN 61 reports information on the received power level of the radio signals sent from BTS 21 and BTS 22 to RNC 2 in a predetermined cycle. RNC 2 determines whether MN 61 needs the soft handover from BTS 21 to BTS 22 based on the information on the received power level for each BTS reported by MN 61. If the soft handover is performed (step 347) and RNC 2 receives data destined for MN 61 from CN 3 (step 348), RNC 2 sends the data to BTS 21 and BTS 22 (step 349).

BTS 21 and BTS 22 convert data, which is received from RNC 2 and destined for MN 61, into radio signals and send the signals to MN 61 (steps 350 and 351). Here, the same data is sent from BTS 21 and BTS 22 to MN 61.

MN 61 Rake-combines the radio signals received from BTS 21 and BTS 22 (step 352).

MN 61 determines whether the data reproduced from the Rake-combined signals is erroneous. When the received data has no error, MN 61 sends a response of ACK to BTS 21. When the received data has an error, MN 61 sends a response of NACK to BTS 21 (step 353). When MN 61 determines whether the data is erroneous based on Rake-combined signals, the same response (a response of ACK or a response of NACK) is sent to BTS 21 and BTS 22.

When BTS 21 and BTS 22 receive the NACK response from MN 61, they resend data to MN 61 (step 354 and 355). [Situation B].

When RNC 2 determines that the soft handover to MN 61 can finish based on the information on the received power level of BTS 21 and BTS 22 reported by MN 61 (step 357), RNC 2 sends the data that is received from CN 3 and destined for MN 61 only to BTS 22 (steps 358, 359).

When BTS 22 receives data destined for MN 61 from RNC 2, BTS 22 converts the data into radio signals and sends the signals to MN 61 (step 360). Here, MN 61 receives data only from BTS 22. Then, the soft handover finishes.

MN 61 determines whether the received data is erroneous. When the received data has no error, MN 61 sends a response of ACK to BTS 22. When the received data has an error, MN 61 sends a response of NACK to BTS 22 (step 361).

When BTS 22 receives the NACK response from MN 61, BTS 22 resends data to MN 61 (step 362). [Situation C].

Soft handover is also described in International Unexamined Patent Application Publication No. WO2004/030396 pamphlet and the like in detail. HARQ is also described in Japanese Patent Laid-Open No. 2006-295912 and the like in detail.

Now, it is assumed that an ACK response is sent from MN 61 to BTS 21 and BTS 22 in the processing performed at steps 354 and 355 in the abovementioned conventional mobile communication system. Here, MN 61 is near the boundary of the cell. Thus, BTS 21 may successfully receive the ACK response and BTS 22 may not successfully receive the ACK response, for example. Then, the ACK response is resent by BTS 22 via HARQ. This situation results from the fact that HARQ is independently performed at each BTS.

Accordingly, the processing performed by BTS 21 and the processing performed by BTS 22 do not match. That causes a problem in that soft handover cannot be performed on MN 61

### SUMMARY OF THE INVENTION

The present invention intends to provide a mobile communication system that enables soft handover even on a Mobil Node (MN) that moves while HARQ is being used, and the soft handover method used in the system.

In order to achieve the abovementioned object, the mobile communication system according to the present invention is a mobile communication system for performing soft handover that is intended to prevent communication from being broken when a mobile node (MN) moves from one cell to another, comprising:

a plurality of base transceiver stations (BTSes) each of which sends data to the MN according to control that is performed by using the Hybrid Automatic Repeat Request (HARQ) at an origin node of the soft handover instead of according to control that is performed by using the HARQ when the BTS is a destination node of the soft handover when the soft handover occurs; and

a radio network controller (RNC) that sends the data only to the BTS that serves the soft handover origin node; and when the data is transferred from the BTS that serves the soft handover origin node, the RNC transfers the data to the BTS that serves the soft handover destination node; and when a request to resend the data is received from the BTS that serves the soft handover destination node, the RNC transfers the resend request to the BTS that serves the soft handover origin node when soft handover is performed.

The soft handover method according to the present invention is a soft handover method performed in a mobile communication system that is intended to prevent communication from being broken when a mobile node (MN) moves from one cell to another, comprising:

sending data to the MN according to control performed by using Hybrid Automatic Repeat Request at an origin node of soft handover instead of according to control performed by using the Hybrid Automatic Repeat Request when a base transceiver station (BTS) is a destination node of soft handover when the soft handover occurs; and

a radio network controller (RNC) sending the data only to the BTS that serves the soft handover origin node; and when the data is transferred from the BTS that serves the soft handover origin node, the RNC transfers the data to the BTS that serves the soft handover destination node; and when a request to resend the data is received from the BTS that serves the soft handover destination node, the RNC transfers the resend request to the BTS that serves the soft handover origin node.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing the configuration of a conventional mobile communication system;

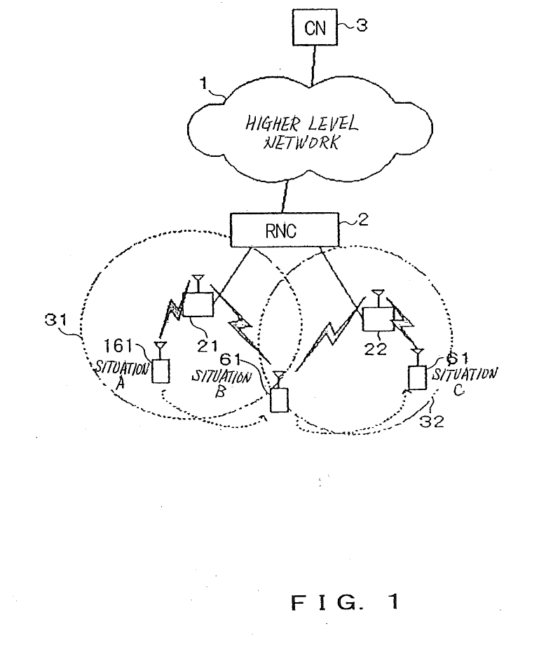

FIG. 2 is a sequence diagram showing the procedure of conventional soft handover;

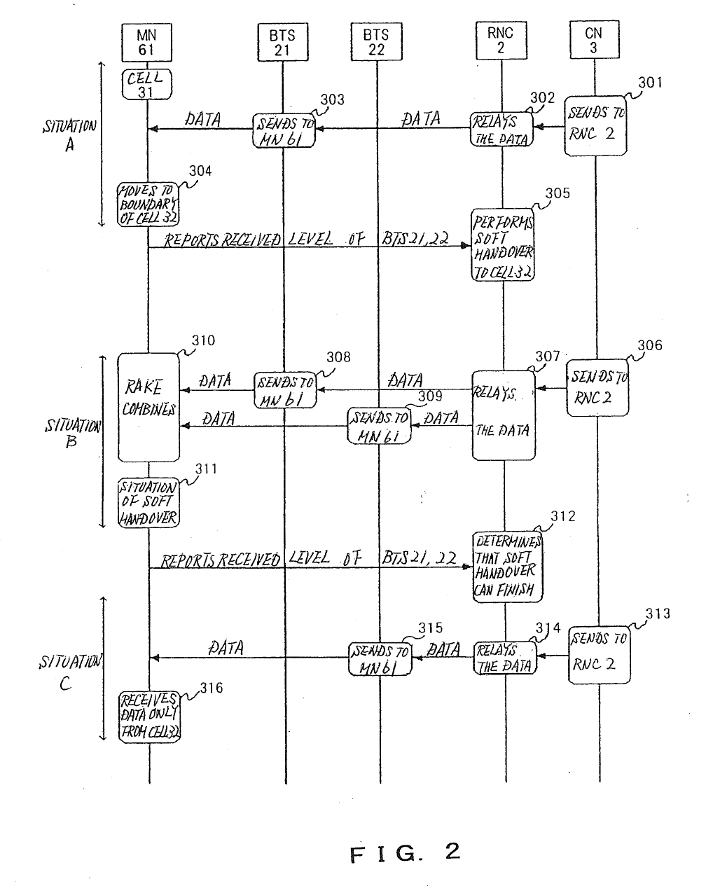

FIG. 3 is a sequence diagram showing the procedure of conventional HARQ;

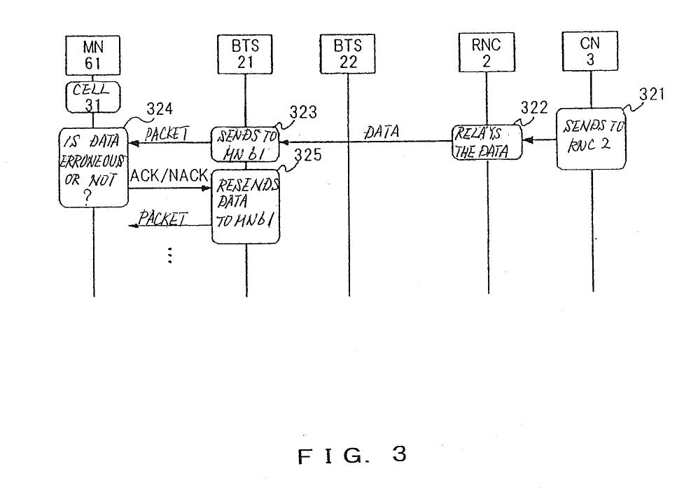

FIG. 4 is a sequence diagram showing a conventional procedure in a case where soft handover is performed while HARQ is being used;

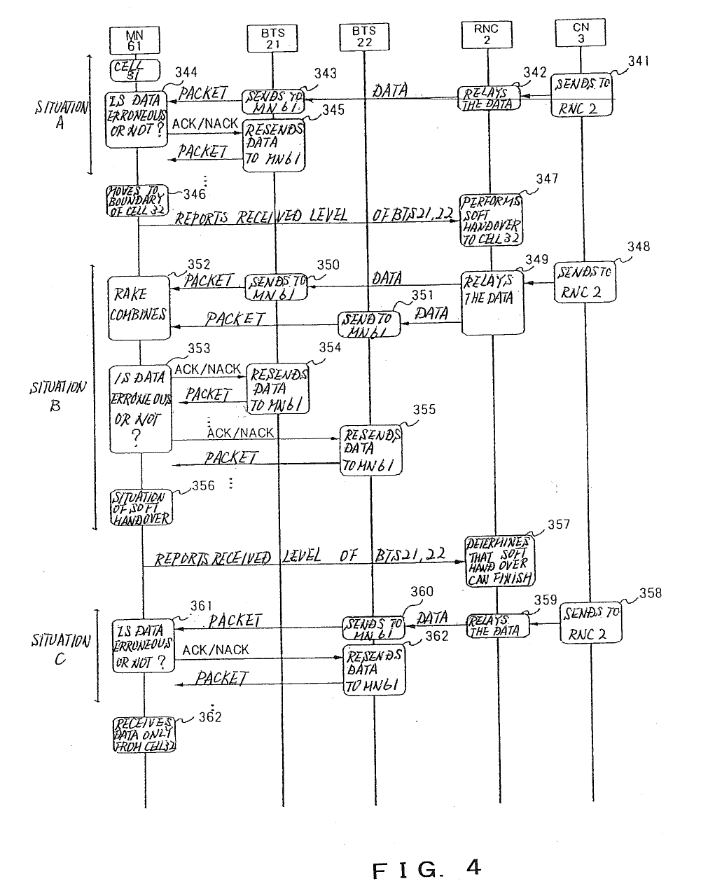

FIG. 5 is a block diagram showing the configuration of the mobile communication system of the present invention; and

FIG. 6 is a sequence diagram showing the procedure of the soft handover method of the present invention.

### DETAILED DESCRIPTION OF THE PREFERRED EMBODIMENTS

Now, the present invention will be described with reference to the drawings.

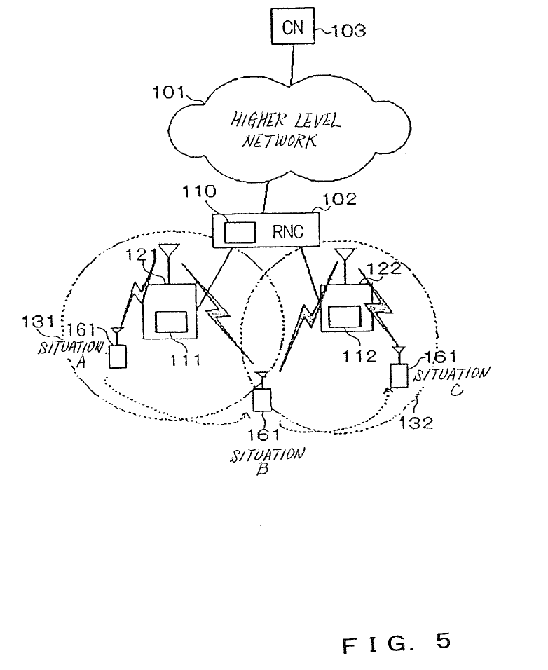

FIG. 5 is a block diagram showing the configuration of the mobile communication system of the present invention.

As shown in FIG. 5, the mobile communication system includes higher level network 101 including a core network, RNC 102 and a plurality of BTSes (only BTS 121 and BTS 122 are shown in FIG. 5). Higher level network 101 including the core network is known to those skilled in the art and not directly related to the present invention. Thus, that is omitted in the detailed description.

RNC 102 is connected to higher level network 101, while including a plurality of BTSes (BTS 121 and BTS 122) connected thereto. CN 103 can communicate with MN 161 when it connects with higher level network 101.

Each of BTS 121 and BTS 122 is capable of wirelessly communicating with a plurality of MNs (only MN 161 is shown in FIG. 5) which are present in a cell managed by BTS 121 and BTS 122, respectively. In the mobile communication system shown in FIG. 5, cell 131 and cell 132 are located side by side with cell 131 being managed by BTS 121 and cell 132 being managed by BTS 122.

MN 161 reports information on a received power level of each BTS to RNC 2 in a predetermined cycle. MN 161 determines whether received data is erroneous by using HARQ. When the received data has no error, MN 161 sends a response of ACK to a transmission origin BTS. When the received data has an error, MN 161 sends a response of NACK to a transmission origin BTS. When MN 161 receives the same data from a plurality of BTSes, it Rake-combines the radio signals to perform the HARQ by using the data reproduced from the Rake-combined signals.

Each of RNC 102, BTS 121, BTS 122 and MN 161 is composed of a LSI (Large Scale Integration) including a logical circuit, for example, or a semiconductor integrated circuit including a CPU, a DSP (Digital Signal Processor) or the like which implements various functions to be described below. When each of RNC 102, BTS 121, BTS 122 and MN 161 has a CPU or a DSP, the CPU or the DSP implements the functions described below by executing processing according to programs recorded in a recording medium (not shown).

The mobile communication system of the present invention has relay functional part 110 in RNC 102, transfer functional part 111 in BTS 121, and transfer functional part 112 in BTS 122.

In the mobile communication system of the present invention, the BTS of the soft handover destination node sends data to MN 161 according to control that is performed by using the HARQ at an origin node of the soft handover when said soft handover occurs. Specifically, the BTS of the soft handover origin node adds redundancy bits to be used in performing HARQ as well as information about the required time schedule for sending the data destined for MN 161 to the data and transfers the data to the BTS of the soft handover destination node via RNC 102. The data will be referred to as transfer data below. When the BTS receives a NACK response from MN 161, it adds redundancy bits to be used in performing HARQ as well as information about the required time schedule for sending the data to be resent to MN 161 to the data and transfers the data to the BTS of the soft handover destination node via RNC 102. If an ACK/NACK response cannot be received by the BTS of the soft handover destination node, the BTS of the soft handover destination node sends a resend request to the BTS of the soft handover origin node. Then, the BTS of the soft handover origin node adds redundancy bits to be used in performing HARQ as well as information about the required time schedule for sending the data to be resent to MN 161 to the data and transfers the data to the BTS of the soft handover destination node via RNC 102.

The data destined to MN 161 is simultaneously sent from the BTS of the soft handover destination node and from the BTS of the soft handover origin node at the designated sending time, and the data to be resent to MN 161 is simultaneously sent from the BTS of the soft handover destination node and from the BTS of the soft handover origin node at the designated resending time.

RNC 102 determines the BTS for managing a cell in which MN 161 is present, and relays the data exchanged between CN 103 and MN 161 through the determined BTS. RNC 102 also determines whether MN 161 needs soft handover or not based on information on the received power level of each BTS reported from MN 161. When soft handover is to be performed, RNC 102 sets a flag that is given to data to be sent to MN 161 indicating that it is under soft handover and sends the data only to the BTS of the soft handover origin node. When relay functional part 110 receives the transferred data from the BTS of the soft handover origin node, it transfers (relays) the data to the BTS of the soft handover destination node.

Each of BTS 121 and BTS 122 relays data exchanged between CN 103 and MN 161 via higher level network 101 and RNC 102 as in the conventional manner. Here, each of BTS 121 and BTS 122 sends data to be sent to MN 161 with redundancy bits for detecting an error or with redundancy bits for correcting an error by using HARQ. When each of BTS 121 and BTS 122 receives a NACK response from MN 161, it resends data to MN 161 by using HARQ.

When each of BTS 121 and BTS 122 included in the mobile communication system of the present invention is the soft handover origin node, each of them checks whether the flagged data received from RNC 102, that indicates that it is undergoing soft handover, has been set or not. When the flag is set, each of BTS 121 and BTS 122 encapsulates data destined to MN 161 with information about the required time schedule for sending the data and transfers the encapsulated data (transfer data) to RNC 102 at transfer functional parts 111 and 112 respectively. The data destined for MN 161 is sent to MN 161 at the sending time. When a NACK response is received from MN 161, each of BTS 121 and BTS 122 encapsulates the data to be resent to MN 161 with information about the required time schedule for resending the data at transfer functional parts 111 and 112 respectively and transfers the encapsulated data (transfer data) to RNC 102 as resend processing. The data to be resent to MN 161 is sent to MN 161 at the resending time. When each of BTS 121 and BTS 122 receives a resend request from a BTS of another soft handover destination node via RNC 102, each of them encapsulates the data to be resent to MN 161 with information about the required time schedule for resending the data and transfer the encapsulated data to RNC 102 at transfer functional parts 111 and 112 respectively. The data to be resent to MN 161 is sent to MN 161 at the resending time schedule. Only if a NACK response is received from MN 161 and the data has been transferred to RNC 102 and then if a request to resend the data is received from the BTS of the other soft handover destination node, will the resend request be ignored.

When each of BTS 121 and BTS 122 is the soft handover destination node and data (transfer data) is transferred from a BTS of another soft handover origin node via RNC 102, each of them deencapsulates the transferred data and sends the data to MN 161 at the designated sending time. When each of them sends the data transferred from the BTS of another soft handover origin node to MN 161 and then receives a NACK response from MN 161, each of them sends a request to resend the data to the BTS of the data transfer destination node via RNC 102 at transfer functional parts 111 and 112 respectively.

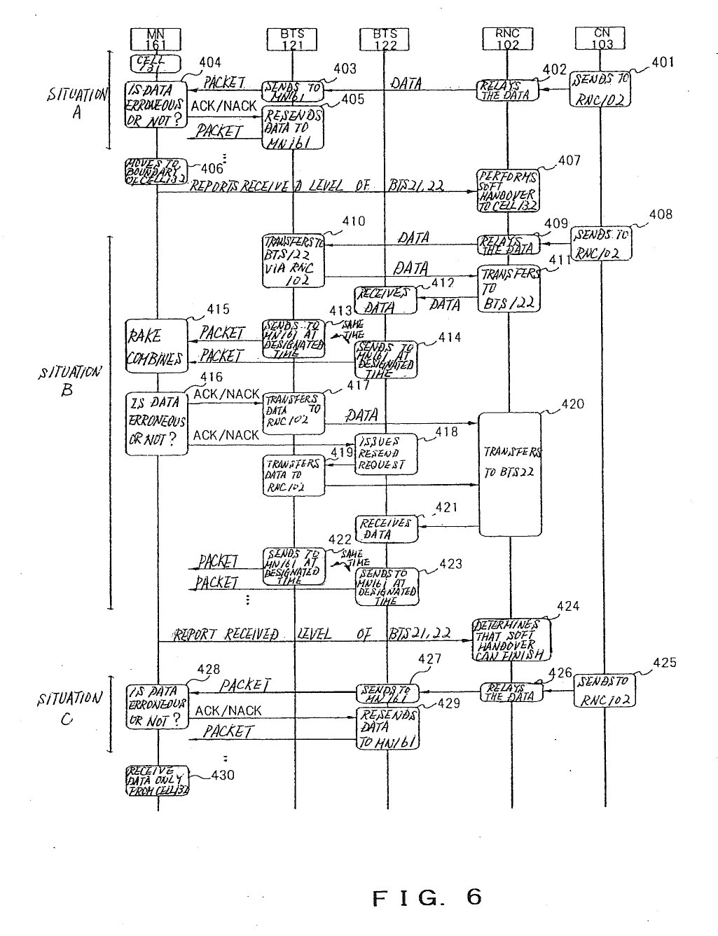

Now, the soft handover of the present invention will be described with reference to FIG. 6.

FIG. 6 is a sequence diagram showing the procedure of the soft handover method of the present invention.

The procedure will be described below by taking a case where MN 161 moves from cell 131 to cell 132 while HARQ is being used. [Situation A→Situation B→Situation C]. When MN 161 moves from cell 132 to cell 131, the operations performed by BTS 121 and BTS 122 are basically the same as those described above except that those performed by BTS 121 and BTS 122 are switched. The radio signals are sent from BTS 121 and BTS 122 at a synchronized time. GPS (Global Positioning System) or the like may be used in synchronizing the sending time. GPS is well-known to those skilled in the art and not directly related to the present invention. Thus, that is omitted in the detailed description.

MN 161 communicates with CN 103 via BTS 121, RNC 102 and the higher level network 101 in cell 131 of the soft handover origin node (step 401). Here, RNC 102 sends the data destined for MN 161 and that is received from CN 103 to BTS 121 (step 402) where the data destined to MN 161 and that is received from RNC 102 is converted into radio signals and sent to MN 161 (step 403).

MN 161 determines whether the received data is erroneous or not by using HARQ. When the received data has no error, MN 161 sends an ACK response to BTS 121, and when the received data has an error, MN 161 sends a NACK response to BTS 121 (step 404). When BTS 121 receives a NACK response from MN 161, it resends the data to MN 161 (step 405). [Situation A].

When MN 161 moves to the boundary of cell 132 (step 406), the soft handover from cell 131 to cell 132 is performed according to the procedure described below.

As mentioned above, MN 161 reports information on the received power level of the radio signals sent from BTS 121 and BTS 122 to RNC 102 by predetermined cycle. RNC 102 determines whether MN 161 needs the soft handover from BTS 121 to BTS 122 or not based on the information on the received power level for each BTS reported by MN 161. If the soft handover is performed (step 407) and if RNC 102 receives data destined for MN 161 from CN 103 (step 408), RNC 102 gives and sets a flag indicating that it is undergoing soft handover to the data and sends the data only to BTS 121 (step 409).

BTS 121 checks the flag included in the data destined for MN 161 and that is received from RNC 102 indicating that it is undergoing the soft handover. When the flag is set, BTS 121 encapsulates data destined for MN 161 with information about the required time schedule for sending the data and transfers the encapsulated data to relay functional part 110 of RNC 102 at transfer functional part 111 (step 410).

When relay functional part 110 of RNC 102 receives the transfer data from BTS 121, it transfers the data to BTS 122 of the soft handover destination node (step 411).

BTS 121 converts the data, which is received from RNC 2 at the time that it is sent, into radio signals and sends them to MN 161 (step 413). When BTS 122 receives the transfer data destined for MN 161 from relay functional part 110 of RNC 102 (step 412), it deencapsulates the data, converts the transferred data destined for MN 161 into radio signals, and sends the radio signals to MN 161 at the designated sending time (step 414). Here, the same data is sent from BTS 121 and BTS 122 to MN 161, which is undergoing the soft handover.

MN 161 Rake-combines the radio signals received from BTS 121 and BTS 122 (step 415).

MN 161 determines whether the data reproduced from the Rake-combined signals is erroneous or not. When the received data has no error, MN 161 sends an ACK response to BTS 121 and BTS 122. When the received data has an error, MN 161 sends an NACK response to BTS 121 and BTS 122 (step 416).

When BTS 121 of the soft handover origin node receives an NACK response from MN 161, it encapsulates the data destined for MN 161 with information about the required time schedule for resending the data and transfers the data to relay functional part 110 of RNC 102 at transfer functional part 111 (step 417). When BTS 122 of the soft handover destination node receives the NACK response from MN 161, it issues a resend request to BTS 121 (data transfer origin) via relay functional part 110 of RNC 102 at transfer functional part 112 (step 418).

If BTS 121 receives a resend request from relay functional part 110 of RNC 102 though it has received an ACK response from MN 161 during processing at step 417, it encapsulates the data destined for MN 161 with information about the required time schedule for resending the data and transfers the data to relay functional part 110 of RNC 102 at transfer functional part 111 (step 419).

If BTS 121 received the NACK response from MN 161 during processing at step 417 and has transferred the data to RNC 102 and then if BTS 121 receives a transfer request, it does not resend the data to RNC 102.

Relay functional part 110 of RNC 102 that received the data that was resent from BTS 121 transfers the data to BTS 122 of the soft handover destination node (step 420). BTS 121 resends the data to MN 161 at the resending time schedule (step 422).

When BTS 122 receives the data to be resent and that is destined for MN 161 from relay functional part 1110 of RNC 102 (step 421), it deencapsulates the data and resends it for MN 161 at the designated resending time (step 423). Here, the same data is sent from BTS 121 and BTS 122 to MN 161, which is undergoing the soft handover. [Situation B].

When RNC 102 determines that soft handover to MN 161 is able to be finished based on information on the received power level of BTS 121 and BTS 122 that is reported from MN 161 (step 424), it sends data destined to MN 161 that is received from CN 103 only to BTS 122 (steps 425 and 426). Here, RNC 102 does not set the flag, that has been given to data that is to be relayed, indicating that it is undergoing the soft handover.

When BTS 122 receives the data destined for MN 161 from RNC 102, it converts the data into radio signals and sends the radio signals to MN 161 (step 427). Here, MN 161 has received data only from BTS 122. The soft handover finishes.

MN 161 determines whether the data received from BTS 122 is erroneous or not. When the received data has no error, MN 161 sends an ACK response to BTS 122, and when the received data has an error, MN 161 sends an NACK response to BTS 122 (step 428).

When BTS 122 receives the NACK response from MN 161, it resends the data to MN 161 (step 429). [Situation C].

As mentioned above, according to the present invention, the BTS of the soft handover destination node sends data to MN 161 according to control that is performed by using the HARQ at an origin node of the soft handover when said soft handover occurs. That prevents a situation in which, when each BTS controls the node by using HARQ independently, the processes which the BTSes perform with not match each other.

Thus, when MN 161 moves from a cell to another cell, while HARQ is being used, the soft handover is available for MN 161. Since soft handover is available, in the mobile communication system using the CDMA, MN 161 can receive radio waves from BTSes 121 and 122 and Rake-combine the radio waves even when received power levels from BTSes 121 and 122 are low as in a situation in which MN 161 is near the boundary of a cell. That improves communication quality.

In the mobile communication system using OFDMA, the guard interval can be minimized. That improves communication efficiency. The transmission power from BTSes 121 and 122 to MN 161 can also be reduced so that radio resources may be effectively used.

While this invention has been particularly shown and described with reference to exemplary embodiments thereof, the invention is not limited to these embodiments. It will be understood by those ordinarily skilled in the art that various changes in form and details may be made therein without departing from the spirit and scope of the present invention as defined by the claims.

What is claimed is:

1. A mobile communication system for performing soft handover that is intended to prevent communication from being broken when a mobile node (MN) moves from one cell to another, comprising:
a plurality of base transceiver stations (BTSes) each of which sends data to said MN according to control that is performed by using the Hybrid Automatic Repeat Request at an origin node of said soft handover instead of according to control that is performed by using said Hybrid Automatic Repeat Request when the BTS is a destination node of said soft handover when said soft handover occurs; and
a radio network controller (RNC) that sends the data only to the BTS that serves said soft handover origin node; and when said data is transferred from the BTS that serves said soft handover origin node, said RNC transfers the data to the BTS that serves said soft handover destination node; and when a request to resend said data is received from the BTS that serves said soft handover destination node, said RNC transfers the resend request to the BTS that serves said soft handover origin node when said soft handover is performed.

2. The mobile communication system according to claim 1, wherein
said BTS
transfers data destined for said MN with information about the required time schedule for sending the data destined for said MN to the BTS that serves said soft handover destination node via said RNC and sends the data destined for said MN to said MN at said required time for sending the data, when said BTS is said soft handover origin node; and
extracts said information at a required time for sending the data from the data transferred from said RNC and sends the data destined for said MN to said MN at the required time for sending the data, when said BTS is said soft handover destination node.

3. The mobile communication system according to claim 1, wherein
said BTS
transfers data to be resent to said MN with information about the required time schedule for resending the data, to be resent to said MN, to the BTS that serves said soft handover destination node via said RNC and sends said data to be resent to said MN at said required time for resending the data, when said BTS is said soft handover origin node and receives a NACK from said MN; and
extracts said information about the required time schedule for resending the data from said data transferred from said RNC and sends said data to be resent to said MN at the time required to resend said data, when said BTS is said soft handover destination node.

4. The mobile communication system according to claim 3, wherein
said BTS
sends a request to resend the data destined for said MN to the BTS that serves said soft handover origin node via said RNC, when said BTS is said soft handover destination node and cannot successfully receive an ACK or a NACK from said MN; and
transfers the data to be resent to said MN with the information about a required time schedule for resending the data to said MN to the BTS that serves said soft handover destination node via said RNC, when said BTS is said soft handover origin node and receives said resend request from the BTS that serves said soft handover destination node.

5. A soft handover method performed in a mobile communication system that is intended to prevent communication from being broken when a mobile node (MN) moves from one cell to another, comprising:
sending data to said MN according to control performed by using Hybrid Automatic Repeat Request at an origin node of soft handover instead of according to control performed by using said Hybrid Automatic Repeat Request when a base transceiver station (BTS) is a destination node of soft handover when said soft handover occurs; and
a radio network controller (RNC) sending the data only to the BTS that serves the soft handover origin node; and when said data is transferred from the BTS that serves said soft handover origin node, said RNC transfers the data to the BTS that serves said soft handover destination node; and when a request to resend said data is received from the BTS that serves said soft handover destination node, said RNC transfers the resend request to the BTS that serves said soft handover origin node.

6. The soft handover method according to claim 5, wherein
when said BTS is said soft handover origin node, said soft handover method comprises:
transferring data destined for said MN with information on the time required to send the data destined for said MN to the BTS that serves said soft handover destination node via said RNC and sending the data destined for said MN to said MN at said time required to send the data, and
when said BTS is said soft handover destination node, said soft handover method comprises:
extracting said information at the time required to send the data from the data transferred from said RNC and sending the data destined for said MN to said MN at the time required to send the data.

7. The soft handover method according to claim 5, wherein
when said BTS is said soft handover origin node, said soft handover method comprises:
transferring data to be resent to said MN with information about a required time schedule for resending the data to said MN to the BTS that serves said soft handover destination node via said RNC and sending said data to be resent to said MN at said required time schedule for resending the data, when said BTS receives a NACK from said MN; and
when said BTS is said soft handover destination node, said soft handover method comprises:
extracting said information about the required time schedule for resending the data from said data transferred from said RNC and sending said data to be resent to said MN at the required time schedule for resending said data.

8. The soft handover method according to claim 7, wherein
when said BTS is said soft handover destination node, said soft handover method comprises:
sending a request to resend the data destined for said MN to the BTS that serves said soft handover origin node via said RNC, when said BTS cannot successfully receive an ACK or a NACK from said MN; and
when said BTS is said soft handover origin node, said soft handover method comprises:
transferring the data to be resent to said MN with the information about the required time schedule for resending the data to the BTS that serves said soft handover destination node via said RNC, when said BTS receives said resend request from the BTS that serves said soft handover destination node.
